(19) United States
(12) Patent Application Publication
(10) Pub. No.: US 2009/0082104 A1
(43) Pub. Date: Mar. 26, 2009

(54) Track-Based Interactive Music Tool Using Game State To Adapt Playback

(75) Inventor: Christopher Hegstrom, Guilgord (GB)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronics Arts, Inc., Redwood City, CA (US)

(21) Appl. No.: 11/860,415

(22) Filed: Sep. 24, 2007

(51) Int. Cl. G06F 17/00

(52) U.S. Cl. 463/35; 463/43

(57) ABSTRACT

An audio player for playing back a plurality of tracks, comprising a game state monitor for monitoring a state of an interactive video game being played by a user of a game device, a track controller for managing a plurality of audio tracks, and a track manager for playing out selected ones of the plurality of audio tracks wherein the selected ones are selected based on game logic and a current game state of the interactive video game.

### FIELD OF THE INVENTION

The present invention relates to interactive video games in general and in particular to providing music or other audio wherein playback depends on state of a game.

### BACKGROUND OF THE INVENTION

Video games typically include multiple scenes, adventures, missions, action sequences, and the like. For example, a game may be divided into various scenarios a user must complete. A typical scene involves one or more images presented to the user and, in one example, each scene is a level that the player(s) need to complete selected tasks, contests, etc. before being allowed to switch from a current level to a next higher level.

At each level, or at each scenario, there are tasks that the user must perform, there are images of a virtual space, perhaps, with characters (user-driven or computer-driven), other objects and background scenery. In addition to video content, a game will commonly provide audio content as well. Some of that audio content is character driven, such as one character speaking to another character. Some of that audio content might be part of an action, such as when the action of a character dropping an object is displayed and an audible sound of the object “hitting” the ground is output. Another example is footstep sounds when a character is “walking” in the virtual space. These are referred to herein as action-incident sounds.

In addition to character sounds and action-incident sounds, there are other sounds output by the video game, referred to herein as environment sounds. Environment sounds might include music tracks that play as background to the action of the video game.

While environment sounds might be pleasing to a novice user, they can be repetitive to the frequent user, so improvements can be made in presenting environment sounds.

### BRIEF SUMMARY OF THE INVENTION

In embodiments of an interactive video game and/or program code that effects an interactive video game when that program code is executed, environment sounds are output with a dependence on one or more of player selection, game state or the like.

In a specific embodiment, the environment sounds comprise music tracks and a plurality of variations are provided for with the variations driven, for example, by what is happening in the game at that moment. Some of the variations can be provided by the player or other end user, but can be done so in a way that maintains consistency of the experience and a measure of control of the game designer, the music provider and the player or end user.

Embodiments of the present invention can be made using computer hardware to implement the functionality, computer software comprising program code made up of instructions that, when executed, perform that functionality, or some combination. The computer software can be special-purpose game hardware or a general-purpose programmable device or system. The present invention can also be embodied on computer-readable media that, when combined with a computer or computing device, implements the invention. Such media might include CD-ROM, DVD, or networked storage such as an Internet-connected file server.

In one embodiment, a computer readable medium that includes embodiments of the present invention is included.

The following detailed description together with the accompanying drawings will provide a better understanding of the nature and advantages of the present invention.

### BRIEF DESCRIPTION OF THE DRAWINGS

FIG. 1 illustrates a game system for providing one or more games for a user according to one embodiment of the present invention.

FIG. 2 illustrates an embodiment of a game device according to the present invention.

FIG. 3 illustrates a flowchart of a sequence of steps for a game that a user is playing according to one embodiment of the present invention.

FIG. 4 illustrates an example of game variable memory as might be used in the game device shown in FIG. 2.

FIG. 5 illustrates an example of a game-state driven track assignment.

FIG. 6 illustrates another example of a game-state driven track assignment.

FIG. 7 illustrates yet another example of a game-state driven track assignment.

### DETAILED DESCRIPTION OF THE INVENTION

An improved interactive video game is described herein. It should be understood that the invention is not limited to a particular type of game hardware, but might apply to consoles, computers, handheld devices, cell phones capable of playing games, and other hardware. Game consoles are made be several vendors, such as Microsoft's Xbox 360™ console, Sony's PS3™ console, and Nintendo's Wii™ console, the portable DS and Sony's portable PSP™ device.

An end user of an interactive video game is often referred to as a “player”. That player is provided with user input devices to convey the player's inputs to the interactive video game and that interactive video game also provides for outputs, such as a video display output and an audio output. Other outputs might also be present, such as a data transfer output (or input/output) for interacting with other game systems and/or storage and/or remote data systems, etc. It should be understood that the actual display is not required for the invention, but can be added to the invention when the user plays the game. For example, the invention might be embodied in instructions forming program code stored on computer-readable media programmed such that ordinary and/or readily available computers, computing devices, game consoles or other platforms can be provided with the program code and/or computer-readable media to provide the player with an interactive game playing experience.

The play of the game depends on what the player does, hence the game is interactive. The play of the game also depends on how the game designer (a programmer, developer or the like) puts together the instructions forming the program code. Additionally, the game designer can provide openings for the end-user player or other third-parties to provide content or additional instructions to the game.

In one example, a game might have been programmed to allow for end-user loading of music tracks as well allowing for end users (and/or their proxies) to specify how music tracks and other environmental sounds are to be played back in particular situations. The game might have been programmed to base playback of environmental sounds based on game state. As used herein, “end user” refers to a person or entity that acquires or possesses a game system that plays the game after it has been passed by the game developer entity.

It is often important for a game developer entity to provide features to customize game play experiences, but that should be done in a way that maintains the usability of the game so as not to discourage others from playing the game and to allow for an easy player experience. In many cases, the end user is the player, but in some cases, the end user sets up a game device and the game is played by others, such as friends of an end user who purchases a game system and a license to a game and customizes their game system, but lets others play. Unless otherwise specified, the descriptions herein should be read to cover end users who are players and who are not.

As is described herein, a game designer designs a game, specifying, among other things, how the game will operate, what levels it will have, what inputs are allowed, what is done with the inputs, the game logic, etc. The game designer, in some embodiments described herein, leave hooks so that a music developer can later add environmental sounds to the game experience by adding in digital representations of those sounds to be added (or links to digital representations) using hooks provided by the game designer. The end user can replace or add environmental sounds after the game is complete and delivered to the end user, using program facilities provided for by the game designer. Adding can be in the form of overlaying, so that more than one sequence exists for a particular game situation, allowing for alternating presentations of those sequences.

The additional environmental sounds might be created by the same artist that provided the “as-shipped” environmental sounds, possibly using consistency constraints so that the additional sounds work well as replacements for the as-shipped sounds. The additional sounds might be downloaded by the end user using a download feature of a game system. However, because of how the game is built, the end user can customize specific tracks (or “stems”) of a song, while the true adaptive authoring is left in the hands of the game developer.

Game state can include many variables, such as current level, current health points, history of prior actions, current location, orientation, position, etc. of one or more characters. A game state can often, but not necessarily, be defined by the values of all of the variables in a variable memory maintained by the game program code. For example, a soccer game that is in a state of eminent scoring by one team might have its state represented by variables that indicate that the soccer ball is in a particular position, has a particular speed and heading and the position of the opposing goalie is such that the logical conclusion of the game being played out is that the ball will stop in a position that is defined as being inside the net.

In many cases, a particular game state might correspond with an observable situation, but in other cases, the game state is internal such that the player is not aware of the specifics. In any case, where game state includes the current values of variables in a variable memory, the play out of environmental sounds can be made dependent on game state.

Exemplary hardware upon which such program code can be executed will now be described, followed by further details of the playing of audio sequences.

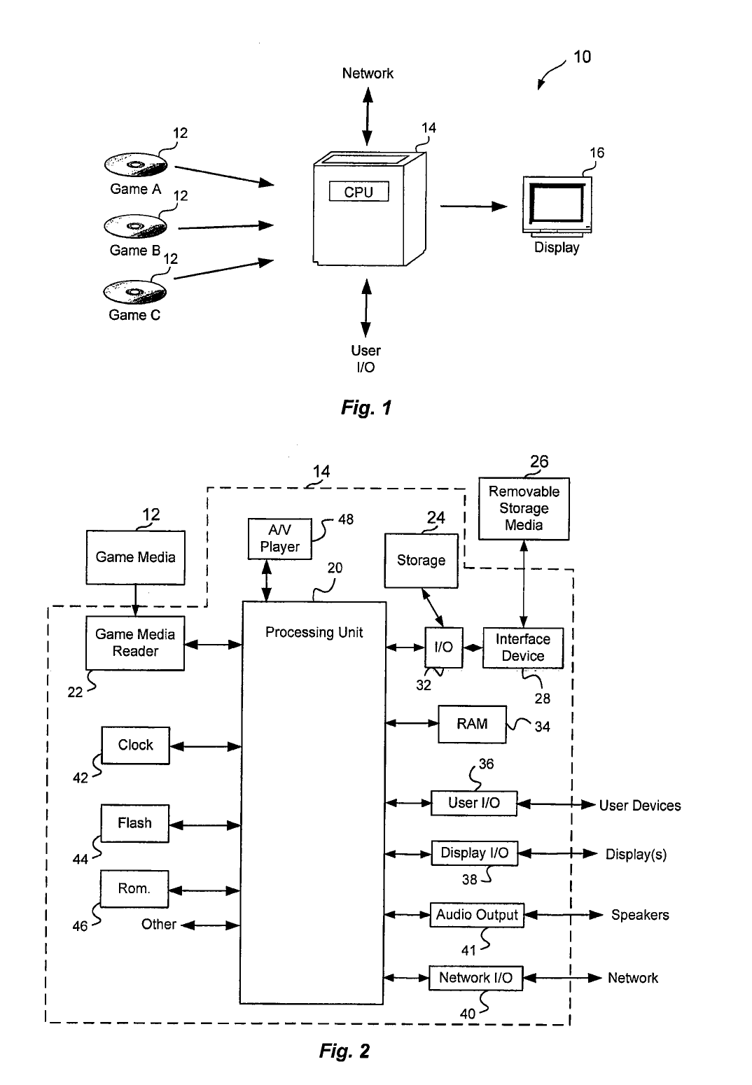

FIG. 1 illustrates a game system 10 for providing one or more games for a user according to one embodiment of the present invention. System 10 is shown including one or more game media 12 (game A, game B, game C), a game device 14, and a display 16.

One or more game media 12 can include any game applications that may be used by game device 14 to involve a player in a game (and possibly also non-players who are also around). Each game medium 12 includes logic to provide a game, denoted as game A, game B, and game C. In one embodiment, the game provided by game device 14 is an electronic video game. Games are each individually stored on media, such as compact disk read-only memories (CDROMs), digital versatile disks (DVDs), game cartridges, or other storage media. A game, such as game A, is inserted in, coupled to, or in communication with game device 14 so that game device 14 may read all or part of a game application program code and/or related game data found on game media 12.

Game device 14 is a computing device that includes a processor, such as a CPU, and data storage combined or in separate elements. Game device 14 may be connected to a network that allows game device 14 to provide games that are not included on one or more game media 12. Thus, game A, game B, and game C may be accessed through the network and not be individually stored on game media 12. To allow a user to select from a plurality of available games, a display 16 might present a list of the games provided by game applications on game media 12. A game application may be also referred to as a game code and/or a game program. A game application should be understood to include software code that game device 14 uses to provide a game for a user to play. A game application might comprise software code that informs game device 14 of processor instructions to execute, but might also include data used in the playing of the game, such as data relating to constants, images and other data structures created by the game developer. A user interacts with the game application and game device 14 through user input/output (I/O) devices.

Display 16 is shown as separate hardware from game device 14, but it should be understood that display 16 could be an integral part of game device 14. It should also be understood that game media 12 could be an integral part of game device 14. Game media 12 might also be remote from game device 14, such as where game media is network storage that game device 14 accesses over a network connection to execute code stored on game media 12 or to download code from game media 12.

FIG. 2 illustrates an embodiment of game device 14 according to embodiments of the present invention. It should be understood that other variations of game device 14 may be substituted for the examples explicitly presented herein and while the hardware might be essential to allow particular player interactivity, it is not essential to an implementation of the invention even if it is essential to the operation of it.

As shown, game device 14 includes a processing unit 20 that interacts with other components of game device 14 and also interacts with external components to game device 14. A game media reader 22 is included that communicates with game media 12. Game media reader 22 may be a CDROM or DVD unit that reads a CDROM, DVD, or any other reader that can receive and read data from game media 12.

Game device 14 also includes various components for enabling input/output, such as an I/O 32, a user I/O 36, a display I/O 38, and a network I/O 40. I/O 32 interacts with a storage 24 and, through an interface device 28, removable storage media 26 in order to provide storage for game device 14. Processing unit 20 communicates through I/O 32 to store data, such as game state data and any data files. In addition to storage 24 and removable storage media 26, game device 14 includes random access memory (RAM) 34. RAM 34 may be used for data that is accessed frequently, such as game variables when a game is being played.

User I/O 36 is used to send and receive commands between processing unit 20 and user devices, such as game controllers. Display I/O 38 provides input/output functions that are used to display images from the game being played. Network I/O 40 is used for input/output functions for a network. Network I/O 40 may be used if a game is being played on-line or being accessed on-line. Audio output 41 comprises software and/or hardware to interface to speakers (such as desktop speakers, speakers integrated in game device 14, earphones, etc.). A game device might also have audio inputs (not shown).

Game device 14 also includes other features that may be used with a game, such as a clock 42, flash memory 44, read-only memory (ROM) 46, and other components. An audio/video player 48 might be present to play a video sequence such as a movie. It should be understood that other components may be provided in game device 14 and that a person skilled in the art will appreciate other variations of game device 14.

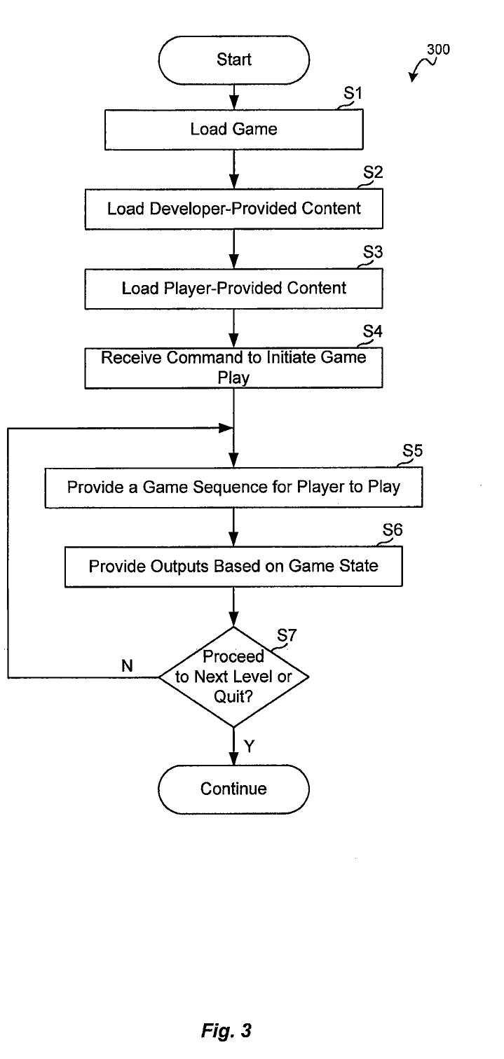

FIG. 3 illustrates a flowchart 300 of a sequence of steps for a game that a player is playing according to one embodiment of the present invention. The steps are labeled S1, S2, S3, but might be performed in an order other than the order of the labels.

In step S1, program code for a game, e.g., game application code, is loaded into a game device. In step S2, developer-provided content (such as developer-provided audio and video) is loaded. In step S3, player-provided content (such as player-provided audio and video) is loaded, preferably using openings or hooks provided by the developer. In step S4, the game begins when the player indicates the game is to start (or this can happen automatically upon loading the game application program code. In step S5, the game application provides the player with a game sequence, and accepts player inputs. In response, in step S6, the game application provides outputs (audio, video, haptic, etc.) consistent with the game state and the particular instructions of the game application program code. This continues (S7) until the game is over, the player moves to a new level, etc.

Game menus might be provided, to allow the player to alter user-alterable settings, load content, etc. The game menu might allow a player to choose from different options, such as starting a game, performing training, creating different players, and other options. The command to start the game might start at the beginning of the game or at a specific scene, game state, scenario, etc. Alternatively, game device 14 may decide where to start the game based on game state information. Although the term “scene” is used here, it should be understood that a scene may be any sequence, such as a mission, action sequence, etc.

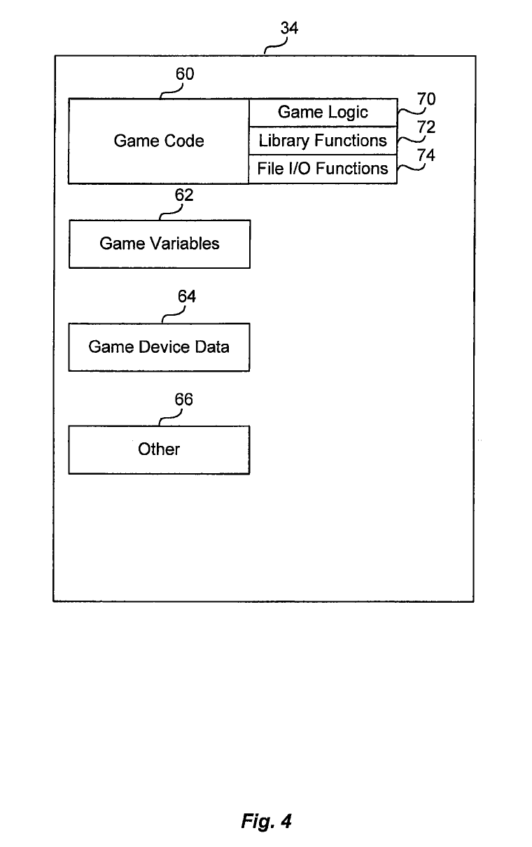

FIG. 4 illustrates an example of data that may be stored in RAM 34 to provide a game according to one embodiment of the present invention. For example, a game code 60, game variables 62, game device data 64, and other data 66 may be downloaded from game media 12 and stored in RAM 34. It will be understood that a person of skill in the art will appreciate other data that may be stored in RAM 34 that will enable game device 14 to provide the game.

Game code 60 may be any logic that is found on game media 12 that is used to provide a game, such as program code comprising a plurality of computer instructions. As shown, game code 60 includes game logic 70, library functions 72, and file I/O functions 74. Game logic 70 is used to provide any functions of the game. Library functions 72 include any functions that are used to support the game. File I/O functions 74 are used by processing unit 20 to perform input/output functions.

Game variables 62 are variables that are specific to a game and are used by processing unit 20 to provide variations of games for different users. The variables allow game device 14 to provide variations to the game based on actions by a user playing the game.

Game device data 64 is data specific to a game hardware that game code 60 is designed for. For example, different versions of game code 60 may be designed for different platforms supported by different game devices 14. Data specifically needed to operate game code 60 on a specific platform for a specific game device 14 may be included in game device data 64. Other data 66 may be any other data that is used with the game.

As a game found on game media 12 is played on game device 14, data regarding the state of the game and any other related aspect of the game may be generated. The game state data is then stored in storage, such as storage 24, removable storage media 26, RAM 34, or any other storage media accessible to game device 14. The game state data may then be used at another time by game device 14 to provide a game that is in the same state as when a user last played the game and saved its state. For example, the game state data may include data that allows a user to continue at a same level that the user has completed, data related to certain achievements that the user has accomplished, etc. It should be noted that the game state data does not necessarily start the game at the same exact place as the place when the game was last stopped but rather may start the game at a certain level or time related to when the game was last stopped or its state was saved.

Game variables might include, for example, view variables, character variables, selection variables, etc. View variables might include, for example, a view point, a view direction (or angle), a view rotation (or orientation), a view extent, cursor location(s), etc. Character variables might include, for example, an array of values for each character active in the game, state data on each character (e.g., name, health level, strength, possessions, alliances, type of character, etc.). Selection variables might include, for example, an array of selected objects.

As used herein, “object” is used to generally refer to logical units of a virtual game space. Examples of objects are trees, characters, clouds, buildings, backgrounds, buttons, tables, lights, etc. Each of these objects might be positioned in a virtual game space, typically a three-dimensional (“3D”) space to emulate actual experience. Some objects are player-manipulable characters.

### Track Controller

Part of the game application is a track manager that manages tracks (from the developer-provided content and or user-provided content) and determines when to output what track and how. Also provided is a track controller. The track controller is used by the developer or a content manager (who might not be a programmer, but decides on what content to insert into a game), but versions of the track controller might also be provided to end users, so that they can load their own content and control the tracks. The term “track”, as used herein, is not limited to a musical composition that stands alone, such as a song, but is used here more generally to refer to an audio sequence. In some recording studio terminology, this might be referred to as a “stem”. Examples of stems include individual components of a mix, usually saved separately or in a separable form.

The track controller might be considered “middleware software” used to integrate music tracks and other audio tracks into a game. However it is provided, the game application might be logically considered to have components, such as a music module that provides environmental sounds and other audio and a game engine that includes the core logic of game play (such as what is supposed to happen at a given point in the game when the player takes a given action).

In one aspect, the track controller considers tracks and subdivides some or all of the tracks into designated tracks that can each reside on a pre-buffered stream. The track controller allows for an adaptive music experience by conditionally altering the playback parameters of each track depending on game-play conditions. Track playback can be configured so that the track is muted, effected, or otherwise varied based on triggers within the game engine.

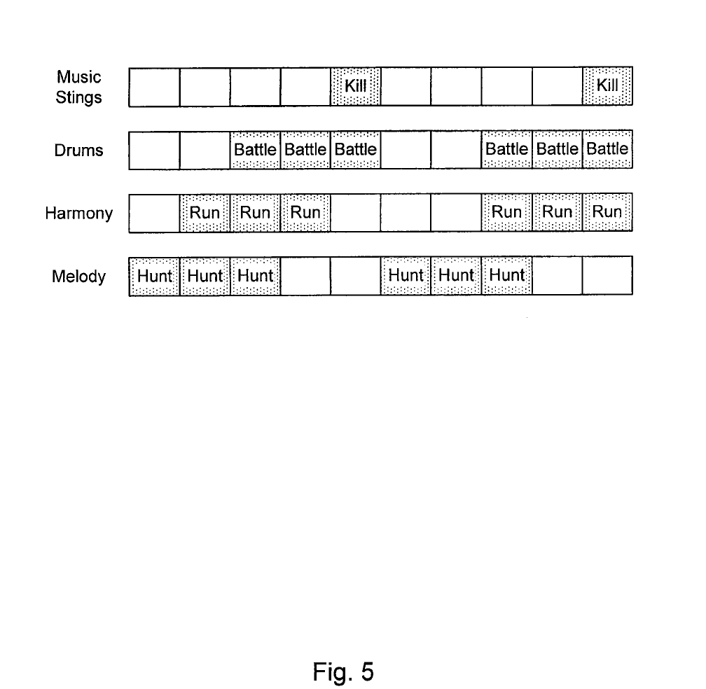

A track can be divided horizontally and/or vertically. FIG. 5 illustrates a track that is divided “vertically” into four substreams, labeled “melody”, “harmony”, “drums” and “music stings”. Each of the vertical substreams can be associated with some game state or condition. For example, the relevant basic game states for a hunting or battling game might be “hunting”, “running”, “battling”, “killing”. As used herein, a music sting track provides a short musical accent phrase.

In FIG. 5, stippled bars indicate an “is playing” state, while blank bars indicate an “is muted” state. Thus, one possible set of rules for track playback is that the melody subtrack plays while the character is hunting (i.e., the game state is “hunt”), the harmony kicks in when the character starts to run, the drums play when the character engages in battle and the music sting track plays when the character completes a successful kill. In this manner, each substream is attached to a bit of game-play logic. The particular association can be provided by the inputs to the track controller. Note that the game developer, such as the person specifying each action and reaction of the game to the player actions, need not also specify exactly which track must play, but can merely specify a label for the subtrack that is to play and the music designer can specify what that music is.

Streams might be subdivided horizontally as well. For example, music tracks can be sectioned horizontally into bars (4 bars, 8 bars, 16 bars, etc.) to allow for dynamic pre-buffering, depending on memory allocation. With horizontal subdividing, musical phrases can complete while the game logic tests game state at the end of each phrase to determine what vertical substreams to start and stop. With all of these tracks composed to work together, simply muting and unmuting them based on game-play parameters is accurate within eight bars (or however long the designer specifies the “blocks” to be).

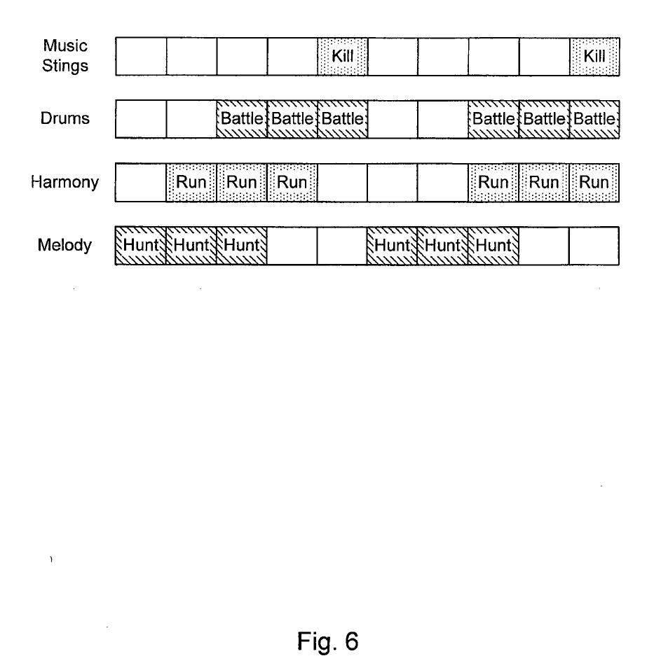

FIG. 6 shows a variation, where player-provided content is used. For example, a player might download new or additional tracks. Such capabilities might be provided as accomplishment awards, as purchases in an online marketplace, by swapping, or other approaches. In the example shown in FIG. 6, suppose the player has downloaded two new tracks and automatically updated the content (such as by using an end-user track controller), so the new “drums” and “melody” subtracks replace the developer-provided ones. Where the original artist of the previous tracks is the same and records and posts the new tracks in the same key and tempo as the original tracks, they would work seamlessly with some new tracks and some prior tracks. In FIG. 6, the player-loaded tracks are indicated with hashing. Since the hard-coded game control logic can remain the same no matter what version of the content is playing back, the music output will appear consistent.

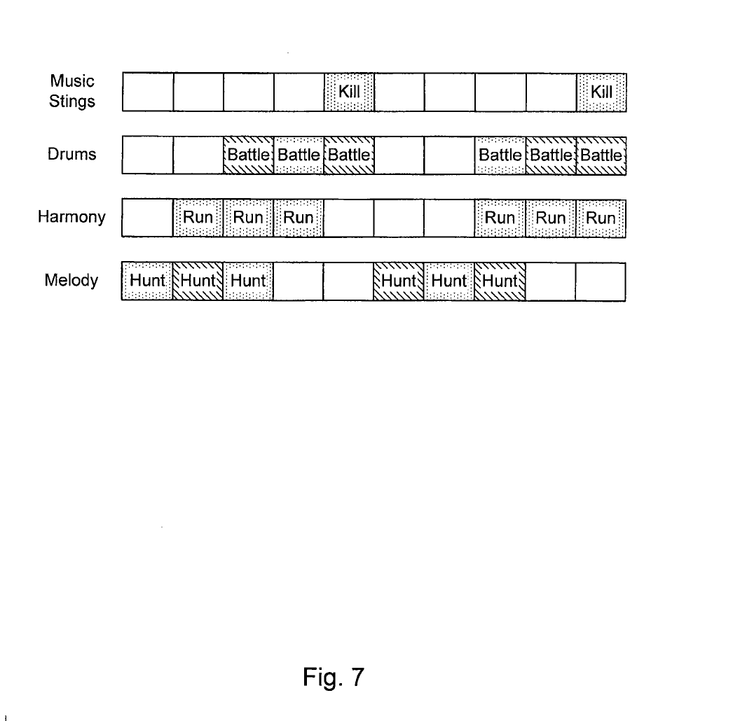

FIG. 7 shows yet another variation, wherein the new tracks do not entirely replace the prior tracks. In that example, the player has set the tracks that have multiple content streams to a random setting, so that the drums and melody subtracks will playback alternating between the original and player-provided content. The player-provided content might be downloaded content, for game devices that provide for downloading content. Again, because these tracks share a common key and tempo, they are interchangeable and provide many interesting combinations for the player. With more downloads, a player might be allowed more variations and with a randomization, the environmental sounds can vary each time the player plays a given scene, for a more interesting experience.

Of course, as users request more and more variations, the music producer for the game might obtain additional tracks from the original artist and upload those for user consumption. With the game logic configured as above, new tracks can be added without changes to the game logic or involvement of the game designer.

Depending on demand and/or interest, the game developers, distributors and/or audio track suppliers licensors, etc., might “sell” audio tracks, or the right to use audio tracks, to the game user. For example, the user might be allowed to download tracks and have them activated for selection under suitable game conditions, such as replacing an existing drum track with a different drum track. Audio tracks might be replaced or added to. The use of additional audio tracks might involve the user paying to download and/or use the additional tracks. In fact, the downloading process could trigger or be associated with a microtransaction with which the user pays for the track. For example, the user might navigate to a game developer's web site, use tools therein to purchase an additional drum or melody track, download them and where the game logic indicates that the developer-provided drum track is to play out, the purchased drum track plays out instead.

A game variation including an updatable, adaptive music system has now been described. In such a system, game developers can map out rules for musical changes based on game state by including logic for multi-track playback in a game engine. The multiple subtracks can be played back simultaneously, giving the facade of one cohesive song, while actually being multiple voices triggering parallel to one another. The end user player can choose from a variety of predefined content tracks that will be written by a composer/music producer/etc. and preloaded with other game content or provided in some other manner (such as being uploaded to an online marketplace for player download). The content can be designed to be interchangeable (same key and tempo), so that any version of the track will synchronize and work aesthetically with other tracks. In addition, such variables can change, but be in unison, to provide variety.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

While the invention has been described with respect to exemplary embodiments, one skilled in the art will recognize that numerous modifications are possible. Thus, although the invention has been described with respect to exemplary embodiments, it will be appreciated that the invention is intended to cover all modifications and equivalents within the scope of the following claims.

1. An audio player for playing back a plurality of tracks, comprising:
game state monitor for monitoring a state of an interactive video game being played by a user of a game device;
a track controller for managing a plurality of audio tracks; and
a track manager for playing out selected ones of the plurality of audio tracks wherein the selected ones are selected based on game logic and a current game state of the interactive video game.

2. The audio player of claim 1, wherein the current game state is represented, at least in part, by a current action of a character of the interactive video game associated with the user of the game device.

3. The audio player of claim 1, wherein the plurality of audio tracks comprises a stings track, a drums track, a melody track and a harmony track.

4. The audio player of claim 1, wherein the track controller comprises logic for downloading user-provided tracks that can replace or overlay tracks provided by a game developer.

5. A method of controlling an audio player that is capable of playing one or more audio tracks stored in a electronic track storage element, the method comprising:
identifying a plurality of audio tracks stored in the electronic track storage element that are capable of being played;
monitoring a state of an interactive video game being played by a user of a game device;
selecting among the plurality of audio tracks to select one or more playout candidate audio tracks, wherein the selection is done dependent on game logic and dependent on a current state of the interactive video game.

6. The method of claim 5, wherein metadata indicating the type of music or sounds represented by an audio track is stored and wherein that metadata is used in selecting which audio track to play out.

7. The method of claim 5, wherein the current game state is represented, at least in part, by a current action of a character of the interactive video game associated with the user of the game device.

8. The method of claim 5, wherein the plurality of audio tracks comprises a stings track, a drums track, a melody track and a harmony track.

9. The method of claim 5, further comprising:
downloading user-provided audio tracks that are separate from audio tracks previously available to the audio player; and
replacing existing audio tracks provided by a game developer, thereby allowing user-provided audio tracks to be selected under conditions where the game logic or the current state of the interactive video game would have triggered the selection of a game developer-provided audio track.

10. The method of claim 5, further comprising:
downloading user-provided audio tracks that are separate from audio tracks previously available to the audio player to increase the number of audio tracks available for selection.

11. The method of claim 5, further comprising:
downloading one or more additional audio tracks that are separate from audio tracks previously available to the audio player;
sending a message over a communications channel to initiate or effect a monetary exchange, wherein the user's ability to cause the selection and/or download of one or more of the one or more additional audio tracks is dependent on completing the monetary exchange.

12. The method of claim 5, wherein the message over the communications channel is a message formatted as a microtransaction that transfers funds from the user's account to an account of the audio track owner/licensor.

13. A track manager for use with an interactive video game being played by a user of a game device, the track manager comprising:
logic to maintain an association with a track identifier and stored data representing an audio track;
logic for selection of a track managed by the track manager, wherein the selection is based on game logic and a current game state of the interactive video game and can vary for different game states at a given point in a game;
logic for determining when additional tracks are available for a game and storing those additional tracks as additional stored data; and
logic for altering selections of tracks such that additional tracks are selected under conditions where earlier stored tracks would have been selected.

14. The track manager of claim 13, further comprising logic for removing earlier stored tracks from the stored data, so that additional tracks replace earlier stored tracks.
